(19) United States
(12) Patent Application Publication
(10) Pub. No.: US 2005/0238553 A1
(43) Pub. Date: Oct. 27, 2005

(54) Container for both a liquid hydrogen fuel and a substance to be hydrogenated

(76) Inventor: Shigeru Kuroda, Shizuoka-Ken (JP)

Correspondence Address: John S. Egbert;Harrison & Egbert, 7th Floor, 412 Main Street, Houston, TX, 77002, US

(21) Appl. No.: 10/925,371

(22) Filed: Aug. 25, 2004

(30) Foreign Application Priority Data
Apr. 27, 2004 (JP) 2004-130548

(51) Int. Cl. F02G 1/04; F01B 29/10

(52) U.S. Cl. 422/187; 60/519

(57) ABSTRACT

A container for both a liquid hydrogen fuel and a substance to be hydrogenated. The container comprises a first containing portion (29) and a second containing portion (33). The first containing portion contains a liquid hydrogen fuel (27) obtained by hydrogenating a substance (25) to be hydrogenated. The second containing portion contains either a substance to be hydrogenated or a substance to be hydrogenated which remains after a liquid hydrogen fuel is dehydrogenated. The capacity of the first containing portion and the capacity of the second containing portion are respectively variable so that the total of the capacities is constant.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a container for both a liquid hydrogen fuel and a substance to be hydrogenated. More particularly, the invention relates to a container for containing a liquid hydrogen fuel obtained by hydrogenating a substance to be hydrogenated, and either a substance to be hydrogenated or a substance to be hydrogenated which remains after a liquid hydrogen fuel is dehydrogenated.

In the present patent application, “a substance to be hydrogenated or a substance to be hydrogenated which remains after a liquid hydrogen fuel is dehydrogenated” means “a substance to be hydrogenated as a new raw material of a liquid hydrogen fuel” or “a substance to be hydrogenated which remains after a liquid hydrogen fuel is dehydrogenated”.

### BACKGROUND OF THE INVENTION

Japanese Patent Laid-Open Publication No. 2001-110437 discloses a hydrogen fuel supply system for a fuel cell utilizing the hydrogenation of an aromatic hydrocarbon such as benzene and naphthalene in the presence of a catalyst, and the dehydrogenation of an organic hydride such as cyclohexane and decalin.

A substance to be hydrogenated such as benzene and naphthalene can be converted by hydrogenation into an organic hydride such as cyclohexane and decalin.

An organic hydride such as cyclohexane and decalin is a safe hydrogen fuel which is liquid at a normal temperature and a normal pressure, and is easy to carry, keep and handle.

It is possible to obtain hydrogen as a fuel by dehydrogenating an organic hydride in the presence of a catalyst such as platinum and at a high temperature. A substance to be hydrogenated such as benzene and naphthalene remains after the organic hydride is dehydrogenated. The substance to be hydrogenated is collected and converted into an organic hydride again by hydrogenation.

In the prior art, a liquid hydrogen fuel such as an organic hydride is produced by hydrogenating a substance to be hydrogenated. A substance to be hydrogenated which remains after the liquid hydrogen fuel is dehydrogenated is collected and converted into a liquid hydrogen fuel again by hydrogenation. Therefore, both a container containing the liquid hydrogen fuel and another container containing the substance to be hydrogenated are used.

With respect to an organic hydride, the containers in the prior art will be described with reference to FIGS. 10 and 11.

In a factory 1 of an organic hydride, the organic hydride is produced by the hydrogenation 5 of a substance to be hydrogenated within a container 3. The organic hydride thus produced is contained in another container 7.

The organic hydride accumulated in the container 7 of the factory 1 is transported to storing facilities 9 of the organic hydride.

In the storing facilities 9 of the organic hydride, the organic hydride transported thereto is stored in another container 7 for the organic hydride.

The organic hydride stored in the container 7 of the storing facilities is transported to using facilities 11 of the organic hydride.

The using facilities 11 of the organic hydride include facilities consuming the organic hydride and facilities supplying hydrogen to hydrogen vehicles.

In the using facilities 11 of the organic hydride, hydrogen is used by the dehydrogenation 13 of the organic hydride in the container 7, and a remaining substance to be hydrogenated is contained in a container 3 for a substance to be hydrogenated.

The substance to be hydrogenated accumulated in the container 3 of the using facilities 11 is transported either via the storing facilities 9 or directly to the factory 1 of the organic hydride. In the factory 1, the substance to be hydrogenated is converted into an organic hydride again by hydrogenation. Thus, the substance to be hydrogenated is collected and used again.

FIG. 11 shows the using facilities 11 of the organic hydride in detail. An organic hydride 15 within the container 7 is subjected to dehydrogenation 13. Hydrogen obtained is used and a remaining substance 17 to be hydrogenated is contained in the container 3 for the substance to be hydrogenated.

In the factory, storing facilities, using facilities, transportation vehicles, etc. of the liquid hydrogen fuel, both the container containing the liquid hydrogen fuel and the container containing the substance to be hydrogenated always exist as mentioned above.

The existence of the two types of containers requires additional space and cost in the factory, storing facilities, using facilities, transportation vehicles, etc. of the liquid hydrogen fuel.

### BRIEF SUMMARY OF THE INVENTION

It is an object of the invention to obviate the above-mentioned disadvantages of the prior art.

It is another object of the invention to provide a container which can contain both a liquid hydrogen fuel and a substance to be hydrogenated.

These and other objects have been achieved by the following container for both a liquid hydrogen fuel and a substance to be hydrogenated.

First, the present invention is a container for both a liquid hydrogen fuel and a substance to be hydrogenated, said container comprising a first containing portion and a second containing portion, said first containing portion containing a liquid hydrogen fuel obtained by hydrogenating a substance to be hydrogenated, said second containing portion containing either a substance to be hydrogenated or a substance to be hydrogenated which remains after a liquid hydrogen fuel is dehydrogenated, the capacity of said first containing portion and the capacity of said second containing portion being respectively variable so that the total of the capacities is constant.

In this embodiment, when the liquid hydrogen fuel is used, the liquid hydrogen fuel contained in the first containing portion is sent out of the first containing portion, hydrogen being removed from the liquid hydrogen fuel by dehydrogenation, a remaining substance to be hydrogenated being sent into the second containing portion. As the liquid hydrogen fuel contained in the first containing portion gradually decreases, the capacity of the first containing portion gradually decreases. At the same time, as the substance to be hydrogenated contained in the second containing portion gradually increases, the capacity of the second containing portion gradually increases.

When the liquid hydrogen fuel is produced, the substance to be hydrogenated contained in the second containing portion is sent out of the second containing portion, said substance being converted into a liquid hydrogen fuel by hydrogenation, said liquid hydrogen fuel being sent into the first containing portion. As the substance to be hydrogenated contained in the second containing portion gradually decreases, he capacity of the second containing portion gradually decreases. At the same time, as the liquid hydrogen fuel contained in the first containing portion gradually increases, the capacity of the first containing portion gradually increases.

In either case, the total of the capacity of the first containing portion and the capacity of the second containing portion is constant. In other words, the total of the volume of the liquid hydrogen fuel and the volume of the substance to be hydrogenated both contained in the same container is constant.

Second, the present invention is a container for both a liquid hydrogen fuel and a substance to be hydrogenated, wherein a movable partition wall is disposed within said container, said partition wall dividing said container into said first containing portion and said second containing portion.

In this embodiment, the capacity of the first containing portion and the capacity of the second containing portion respectively vary when the partition wall moves within the container. The total of these capacities is constant. See FIGS. 1 to 3.

Third, the present invention is a container for both a liquid hydrogen fuel and a substance to be hydrogenated, wherein a containing bag is disposed within said container, said containing bag being expandable and contractible, said containing bag forming said first containing portion, an inner portion of said container other than said containing bag forming said second containing portion.

As the containing bag forming the first containing portion expands within the container, the capacity of the second containing portion becomes smaller. As the containing bag forming the first containing portion contracts within the container, the capacity of the second containing portion becomes larger. In either case, the total of the capacity of the first containing portion and the capacity of the second containing portion is constant. See FIG. 4.

Fourth, the present invention is a container for both a liquid hydrogen fuel and a substance to be hydrogenated, wherein a containing bag is disposed within said container, said containing bag being expandable and contractible, said containing bag forming said second containing portion, an inner portion of said container other than said containing bag forming said first containing portion.

As the containing bag forming the second containing portion expands within the container, the capacity of the first containing portion becomes smaller. As the containing bag forming the second containing portion contracts within the container, the capacity of the first containing portion becomes larger. In either case, the total of the capacity of the first containing portion and the capacity of the second containing portion is constant. See FIG. 5.

Fifth, the present invention is a container for both a liquid hydrogen fuel and a substance to be hydrogenated, wherein a first containing bag and a second containing bag are disposed within said container, said first containing bag containing a liquid hydrogen fuel obtained by hydrogenating a substance to be hydrogenated, said second containing bag containing either a substance to be hydrogenated or a substance to be hydrogenated which remains after a liquid hydrogen fuel is dehydrogenated, said first containing bag being expandable and contractible, said second containing bag being expandable and contractible.

In this embodiment, when the liquid hydrogen fuel is used, the liquid hydrogen fuel contained in the first containing bag is sent out of the first containing bag, hydrogen being removed from the liquid hydrogen fuel by dehydrogenation, a remaining substance to be hydrogenated being sent into the second containing bag. As the liquid hydrogen fuel contained in the first containing bag gradually decreases, the capacity of the first containing bag gradually decreases. At the same time, as the substance to be hydrogenated contained in the second containing bag gradually increases, the capacity of the second containing bag gradually increases.

When the liquid hydrogen fuel is produced, the substance to be hydrogenated contained in the second containing bag is sent out of the second containing bag, said substance being converted into a liquid hydrogen fuel by hydrogenation, said liquid hydrogen fuel being sent into the first containing bag. As the substance to be hydrogenated contained in the second containing bag gradually decreases, he capacity of the second containing bag gradually decreases. At the same time, as the liquid hydrogen fuel contained in the first containing bag gradually increases, the capacity of the first containing bag gradually increases. See FIGS. 6 and 7.

Sixth, the present invention is a container for both a liquid hydrogen fuel and a substance to be hydrogenated, wherein said liquid hydrogen fuel is an organic hydride.

The organic hydride is a safe hydrogen fuel which is liquid at a normal temperature and a normal pressure, and is easy to carry, keep and handle.

Thus, according to the present invention, both a liquid hydrogen fuel and a substance to be hydrogenated are contained in a single container. The single container always contains one or both of said liquid hydrogen fuel and said substance to be hydrogenated. It is enough that the container of the present invention has the same capacity as the conventional container containing either a liquid hydrogen fuel or a substance to be hydrogenated.

As compared with the prior art which always requires both said container for a liquid hydrogen fuel and said another container for a substance to be hydrogenated, the container according to the present invention is advantageous in the space, cost, etc. of the factory, storing facilities, using facilities, transportation vehicles, etc. of the liquid hydrogen fuel.

### BRIEF DESCRIPTION OF THE SEVERAL VIEWS OF THE DRAWINGS

FIG. 1 is a sectional view showing an example of the container according to the present invention.

FIG. 2 is a sectional view showing another example of the container according to the present invention.

FIG. 3 is a sectional view showing a further example of the container according to the present invention.

FIG. 4 is a sectional view showing a further example of the container according to the present invention.

FIG. 5 is a sectional view showing a further example of the container according to the present invention.

FIG. 6 is a sectional view showing a further example of the container according to the present invention.

FIG. 7 is a sectional view showing a further example of the container according to the present invention.

FIG. 8 is a sectional view showing containers according to the present invention in use.

FIG. 9 is schematic view showing containers according to the present invention in use.

FIG. 10 is a schematic view showing containers of the prior art in use.

FIG. 11 is a sectional view showing containers of the prior art.

### DETAILED DESCRIPTION OF THE INVENTION

The invention will now be described in detail with reference to the attached drawings.

Reference symbol 21 represents a container for both a liquid hydrogen fuel and a substance to be hydrogenated. Reference symbol 23 represents a case of the container 21.

The case 23 comprises a first containing portion 29 and a second containing portion 33. The first containing portion 29 contains a liquid hydrogen fuel 27 obtained by hydrogenating a substance 25 to be hydrogenated. The second containing portion 33 contains either a substance 25 to be hydrogenated or a substance 25 to be hydrogenated which remains after a liquid hydrogen fuel 27 is subjected to dehydrogenation 31.

The capacity of the first containing portion 29 and the capacity of the second containing portion 33 are respectively variable so that the total of the capacity of the first containing portion 29 and the capacity of the second containing portion 33 is constant.

The substance 25 to be hydrogenated may be an aromatic hydrocarbon such as benzene and naphthalene.

The liquid hydrogen fuel 27 may be an organic hydride such as cyclohexane and decalin obtained by hydrogenating the substance 25 to be hydrogenated.

It is possible to obtain hydrogen as a fuel by dehydrogenating (31) an organic hydride in the presence of a catalyst such as platinum and at a high temperature. A substance 25 to be hydrogenated such as benzene and naphthalene remains after the organic hydride is dehydrogenated.

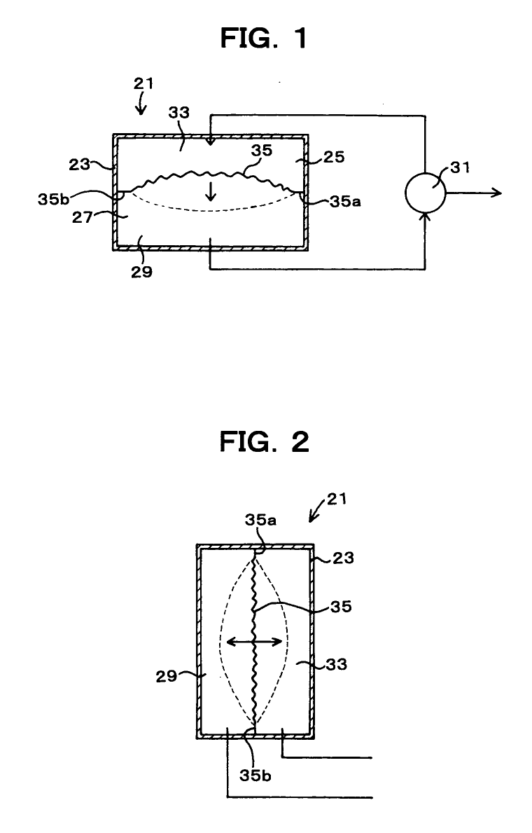

In an embodiment shown in FIG. 1, a movable partition wall 35 is disposed in a horizontal direction within the case 23. The partition wall 35 divides the case 23 into the first containing portion 29 and the second containing portion 33. The movable partition wall 35 may be flexible and two ends 35a, 35b thereof may be fixed to the inner surfaces of the case 23.

In an embodiment shown in FIG. 2, a movable partition wall 35 is disposed in a vertical direction within the case 23. The partition wall 35 divides the case 23 into the first containing portion 29 and the second containing portion 33. The movable partition wall 35 may be flexible and two ends 35a, 35b thereof may be fixed to the inner surfaces of the case 23.

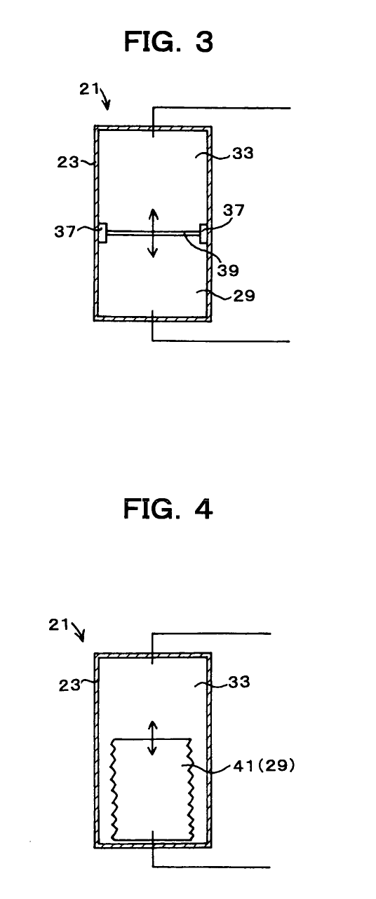

In an embodiment shown in FIG. 3, a movable partition wall 39 is disposed within the case 23 so as to slide along the inner surfaces of the case 23 through sealing means 37. The partition wall 39 divides the case 23 into the first containing portion 29 and the second containing portion 33.

In an embodiment shown in FIG. 4, a containing bag 41 is disposed within the case 23. The containing bag 41 is expandable and contractible. The containing bag 41 may have walls like bellows. The containing bag 41 forms the first containing portion 29, and an inner portion of the case 23 other than the containing bag 41 forms the second containing portion 33.

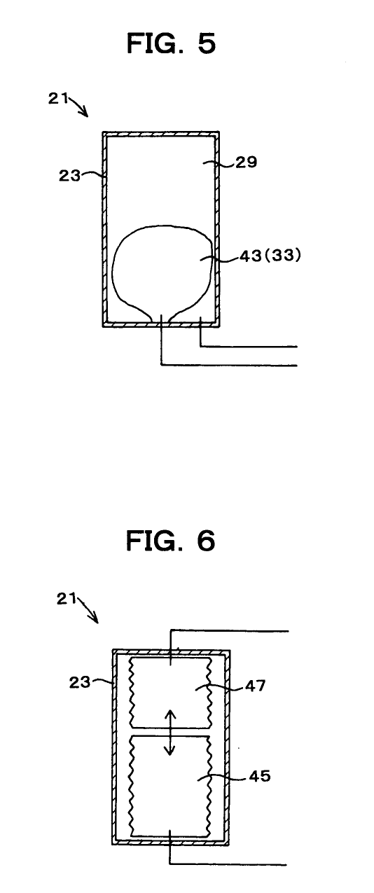

In an embodiment shown in FIG. 5, a containing bag 43 is disposed within the case 23. The containing bag 43 is expandable and contractible. The containing bag 43 may be like a balloon. The containing bag 43 forms the second containing portion 33, and an inner portion of the case 23 other than the containing bag 43 forms the first containing portion 29.

In an embodiment shown in FIG. 6, a first containing bag 45 and a second containing bag 47 are disposed within the case 23. The first containing bag 45 contains a liquid hydrogen fuel obtained by hydrogenating a substance to be hydrogenated. The second containing bag 47 contains either a substance to be hydrogenated or a substance to be hydrogenated which remains after a liquid hydrogen fuel is dehydrogenated. Both of the first containing bag 45 and the second containing bag 47 are expandable and contractible. Both of the first containing bag 45 and the second containing bag 47 may have walls like bellows.

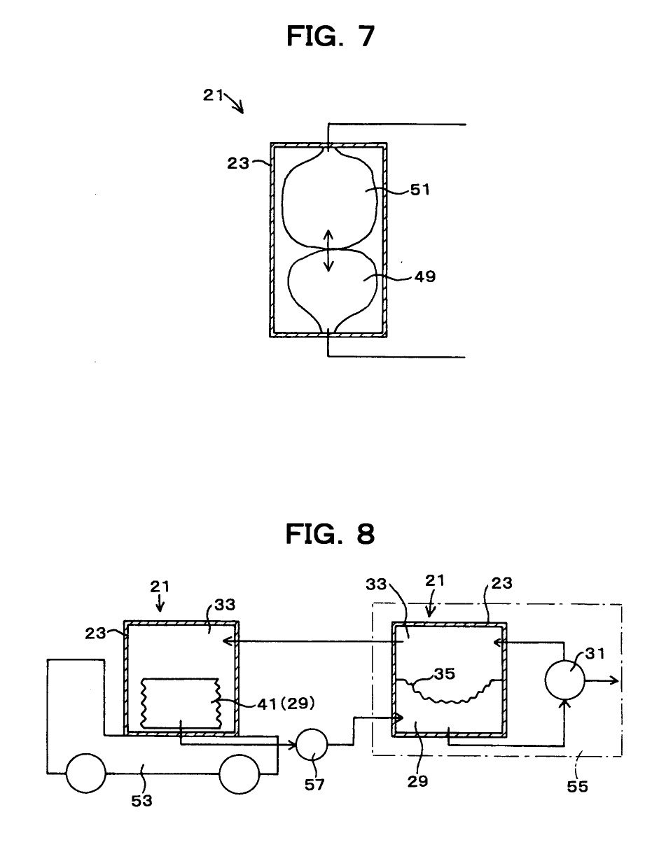

In an embodiment shown in FIG. 7, a first containing bag 49 and a second containing bag 51 are disposed within the case 23. The first containing bag 49 contains a liquid hydrogen fuel obtained by hydrogenating a substance to be hydrogenated. The second containing bag 51 contains either a substance to be hydrogenated or a substance to be hydrogenated which remains after a liquid hydrogen fuel is dehydrogenated. Both of the first containing bag 49 and the second containing bag 51 are expandable and contractible. Both of the first containing bag 49 and the second containing bag 51 may be like balloons.

In FIG. 8, a transportation vehicle 53 is supplying a liquid hydrogen fuel to using facilities 55. The liquid hydrogen fuel in the containing bag 41 (first containing portion 29) of the container 21 on the transportation vehicle 53 is supplied to the first containing portion 29 of the container 21 in the using facilities 55 by a pump 57. At the same time, the substance to be hydrogenated within the second containing portion 33 of the container 21 in the using facilities 55 is returned to the second containing portion 33 of the container 21 on the transportation vehicle 53. The transportation vehicle 53 fully loaded with the liquid hydrogen fuel in the container 21 goes to the using facilities 55, supplies the liquid hydrogen fuel to the using facilities 55, receives the substance to be hydrogenated from the using facilities 55, and goes back fully loaded with the substance to be hydrogenated in the container 21. This means that the transportation vehicle 53 does not have to carry the container 21 in an empty condition and can be used efficiently.

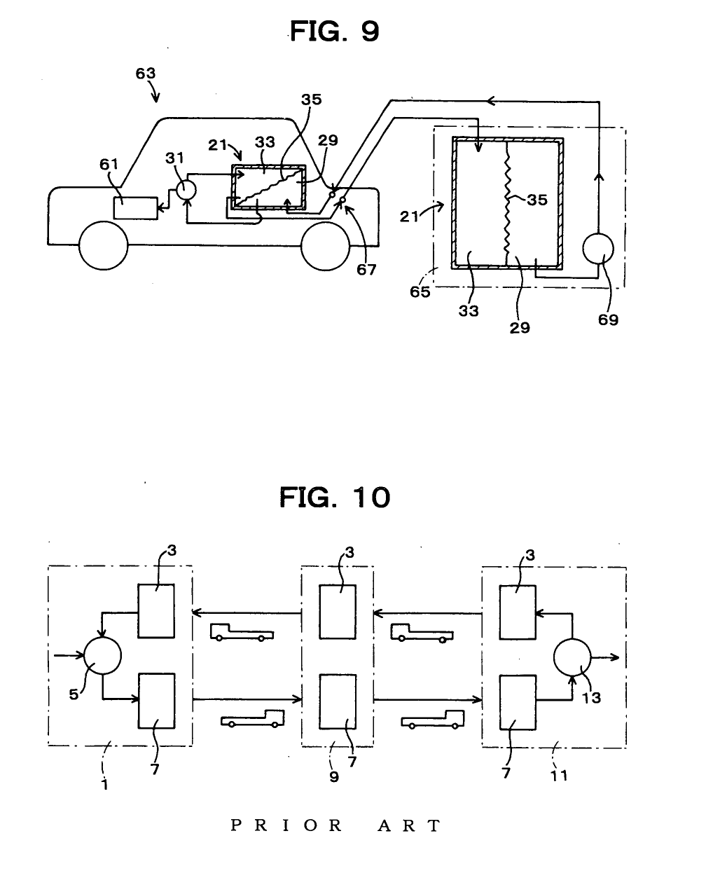

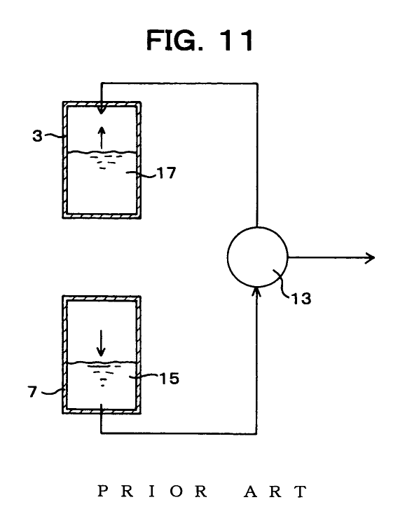

In FIG. 9, an automobile 63 equipped with an engine 61 using a liquid hydrogen fuel is the using facilities 55 of the liquid hydrogen fuel. The automobile 63 is receiving liquid hydrogen fuel at a service station 65 serving as the storing facilities and, at the same time, supplying a substance to be hydrogenated to the service station 65.

The automobile 63 has the container 21 for both a liquid hydrogen fuel and a substance to be hydrogenated. In the automobile 63, hydrogen is removed from the liquid hydrogen fuel in the first containing portion 29 of the container 21 by dehydrogenation 31 and supplied to the engine 61, the remaining substance to be hydrogenated being returned to the second containing portion 33 of the container 21.

The automobile 63 has couplers 67. The automobile 63 receives the liquid hydrogen fuel from the service station 65 through one of the couplers 67 and returns the substance to be hydrogenated to the service station 65 through another coupler 67. As the liquid hydrogen fuel in the first containing portion 29 of the container 21 in the service station 65 is supplied through one of the couplers 67 to the automobile 63 by a pump 69, the substance to be hydrogenated in the second containing portion 33 of the container 21 in the automobile 63 is returned through another coupler 67 to the service station 65.

As many apparently widely different embodiments of the present invention may be made without departing from the spirit and scope thereof, it is to be understood that the invention is not limited to the specific embodiments thereof except as defined in the appended claims.

1. A container for both a liquid hydrogen fuel and a substance to be hydrogenated, said container comprising:
a first containing portion and a second containing portion, said first containing portion containing a liquid hydrogen fuel obtained by hydrogenating a substance to be hydrogenated, said second containing portion containing either a substance to be hydrogenated or a substance to be hydrogenated which remains after a liquid hydrogen fuel is dehydrogenated, wherein a capacity of said first containing portion and a capacity of said second containing portion are respectively variable so that a total of the capacities is constant.

2. A container as claimed in claim 1, further comprising: a movable partition walls disposed within said container, said partition wall dividing said container into said first containing portion and said second containing portion.

3. A container as claimed in claim 1, further comprising:
a containing bag disposed within said container, said containing bag being expandable and contractible, said containing bag forming said first containing portion, an inner portion of said container other than said containing bag forming said second containing portion.

4. A container as claimed in claim 1, further comprising:
a containing bag disposed within said container, said containing bag being expandable and contractible, said containing bag forming said second containing portion, an inner portion of said container other than said containing bag forming said first containing portion.

5. A container for both a liquid hydrogen fuel and a substance to be hydrogenated, comprising:
a first containing bag and a second containing bag disposed within a holding container, said first containing bag containing a liquid hydrogen fuel obtained by hydrogenating a substance to be hydrogenated, said second containing bag containing either a substance to be hydrogenated or a substance to be hydrogenated which remains after a liquid hydrogen fuel is dehydrogenated, said first containing bag being expandable and contractible, said second containing bag being expandable and contractible.

6. A container as claimed in claim 1, wherein said liquid hydrogen fuel is an organic hydride.
